(19) United States
(12) Patent Application Publication
(10) Pub. No.: US 2026/0052505 A1
(43) Pub. Date: Feb. 19, 2026

(54) POSITIONING INTEGRITY DETERMINATION METHODS, APPARATUS, DEVICE, AND MEDIUM

(71) Applicant: Beijing Xiaomi Mobile Software Co., Ltd., Beijing (CN)

(72) Inventor: Xiaolong LI, Beijing (CN)

(21) Appl. No.: 19/101,879

(22) PCT Filed: Aug. 9, 2022
(86) PCT No.: PCT/CN2022/111250

§ 371 Date: Feb. 6, 2025

(51) Int. Cl. H04W 64/00

(52) U.S. Cl. CPC H04W 64/00

(57) ABSTRACT

A method for determining positioning integrity includes: sending first assisting information, where the first assistance information is used for assisting a location management function (LMF) in determining the positioning integrity of a terminal. LMF.

### CROSS-REFERENCE

The present application is a U.S. National Stage of International Application No. PCT/CN2022/111250, filed on Aug. 9, 2022, the contents of all of which are incorporated herein by reference in their entireties for all purposes.

### BACKGROUND OF THE INVENTION

For a positioning technology, a concept of positioning integrity is introduced in new radio (NR). Positioning integrity for an assisting-global navigation satellite system (A-GNSS) positioning technology has been standardized, and terminal-based positioning integrity can be supported.

Specifically, after a terminal determines a protection level (PL), the PL is reported to a location management function (LMF).

### SUMMARY OF THE INVENTION

Examples of the disclosure provide a method and device for determining positioning integrity, a device, and a medium. The technical solutions are as follows:

According to the first aspect of the disclosure, a method for determining positioning integrity is provided. The method is performed by a terminal and includes:
sending first assistance information. The first assistance information is used for assisting a location management function (LMF) in determining the positioning integrity of the terminal.

According to the second aspect of the disclosure, a method for determining positioning integrity is provided. The method is performed by an LMF or an access network device and includes:
receiving first assistance information of a terminal. The first assistance information is used for assisting the LMF in determining the positioning integrity of the terminal.

According to the third aspect of the disclosure, a terminal is provided. The terminal includes: a processor; a transceiver connected to the processor; and a memory for storing an executable instruction for the processor. The processor is configured to load and execute the executable instruction to perform the following method: sending first assistance information, where the first assistance information is used for assisting a location management function (LMF) in determining the positioning integrity of the terminal.

According to the fourth aspect of the disclosure, an LMF or an access network device is provided. The LMF or an access network device includes: a processor; a transceiver connected to the processor; and a memory for storing an executable instruction for the processor. The processor is configured to load and execute the executable instruction to perform the method for determining positioning integrity as mentioned in the second aspect.

According to the fifth aspect of the disclosure, a non-transitory computer-readable storage medium is provided. An executable instruction is stored in the readable storage medium. The executable instruction is loaded and executed by a processor to implement the method for determining positioning integrity as mentioned in the first aspect.

### BRIEF DESCRIPTION OF DRAWINGS

FIG. 1 is a schematic diagram of a communication system according to an example of the disclosure;

FIG. 2 is a flow diagram of a method for determining positioning integrity according to an example of the disclosure;

FIG. 3 is a flow diagram of a method for determining positioning integrity according to an example of the disclosure;

FIG. 4 is a flow diagram of a method for determining positioning integrity according to an example of the disclosure;

FIG. 5 is a flow diagram of a method for determining positioning integrity according to an example of the disclosure;

FIG. 6 is a flow diagram of a method for determining positioning integrity according to an example of the disclosure;

FIG. 7 is a flow diagram of a method for determining positioning integrity according to an example of the disclosure;

FIG. 8 is a flow diagram of a method for determining positioning integrity according to an example of the disclosure;

FIG. 9 is a flow diagram of a method for determining positioning integrity according to an example of the disclosure;

FIG. 10 is a flow diagram of a method for determining positioning integrity according to an example of the disclosure;

FIG. 11 is a flow diagram of a method for determining positioning integrity according to an example of the disclosure;

FIG. 12 is a flow diagram of a method for determining positioning integrity according to an example of the disclosure;

FIG. 13 is a flow diagram of a method for determining positioning integrity according to an example of the disclosure;

FIG. 14 is a flow diagram of a method for determining positioning integrity according to an example of the disclosure;

FIG. 15 is a flow diagram of a method for determining positioning integrity according to an example of the disclosure;

FIG. 16 is a flow diagram of a method for determining positioning integrity according to an example of the disclosure;

FIG. 17 is a structural block diagram of a device for determining positioning integrity according to an example of the disclosure;

FIG. 18 is a structural block diagram of a device for determining positioning integrity according to an example of the disclosure;

FIG. 19 is a structural block diagram of a device for determining positioning integrity according to an example of the disclosure;

FIG. 20 is a structural block diagram of a device for determining positioning integrity according to an example of the disclosure; and

FIG. 21 is a schematic structural diagram of a communication device according to an example of the disclosure.

### DETAILED DESCRIPTION OF THE INVENTION

In order to make the objectives, technical solutions, and advantages of the disclosure clearer, embodiments of the disclosure will be further described in detail below in combination with accompanying drawings.

Examples will be described in detail here, and are illustratively stated in accompanying drawings. When the following descriptions involve accompanying drawings, unless otherwise stated, the same numerals in different accompanying drawings denote the same or similar elements. The embodiments described in the following examples do not represent all implementations consistent with the disclosure. On the contrary, the embodiments are merely instances of a device and a method consistent with some aspects of the disclosure as detailed in the appended claims.

The terms used in the disclosure are merely used to describe the particular examples, and are not intended to limit the disclosure. The singular forms such as “a”, “an”, “the” and “this” used in the disclosure and the appended claims are also intended to include the plural forms, unless otherwise clearly stated in the context. It should also be understood that the term “and/or” used here refers to and includes any or all possible combinations of one or more of associated listed items.

It should be understood that although the terms “first”, “second”, “third”, etc. may be employed in the disclosure to describe various types of information, such information should not be limited to these terms. These terms are merely used to distinguish the same type of information from each other. For instance, without departing from the scope of the disclosure, first information can alternatively be referred to as second information. Similarly, second information can alternatively be referred to as first information. Depending on the context, the word “if” used here can be interpreted as “when”, “in a case that”, or “in response to determining”.

The disclosure relates to the field of mobile communication, and particularly relates to a method and device for determining positioning integrity, a device, and a medium.

Firstly, related technologies involved in examples of the disclosure will be introduced.

For a positioning technology, a concept of positioning integrity is introduced in new radio (NR). The positioning integrity is used for measuring a confidence level of accuracy of position related data provided by a positioning system, and a capability to provide a timely and effective warning to a location service (LCS) in a case that the positioning system does not satisfy a predetermined operating condition.

Positioning integrity of an assisting-global navigation satellite system (A-GNSS) positioning technology is currently standardized, and only positioning integrity based on user equipment (UE) is supported. The positioning integrity based on UE means that the UE determines its own positioning integrity. Specifically, the UE determines a protection level (PL) and reports the PL to a location management function (LMF.

The protection level (PL) refers to a statistical upper limit of a positioning error (PE). The PL is required to ensure that a probability that duration during which a true error per unit time is greater than an alert limit (AL) and the PL is less than or equal to the AL goes beyond time-to-alert (TTA) is less than a required target integrity risk (TIR). The PL is required to satisfy an inequality as follows:
probability of [((PE>AL)&(PL<=AL)) longer than TTA] per unit time<required TIR.

In a case that the PL defines the positioning error in a horizontal plane or a vertical axis, the PL is referred to as a horizontal PL (HPL) or a vertical PL (VPL).

Target integrity risk (TIR): a probability that a positioning error goes beyond an alert limit (AL) without alerting a user within required time-to-alert (TTA). The TIR is generally defined as a probability per unit time (such as per hour, per second, or per independent time sample).

Alert limit (AL): a maximum allowable positioning error that enables a positioning system to be used for a predetermined application. If the positioning error goes beyond the AL range, the positioning system should be declared unusable in the predetermined application such that positioning integrity can be prevented from being lost. In a case that the AL limits the positioning error in the horizontal plane or the vertical axis, the AL is referred to as a horizontal AL (HAL) or a vertical AL (VAL) respectively.

Time-to-alert (TTA): maximum allowable time from time when a positioning error goes beyond an alarm limit (AL) to time when a corresponding an alarm is raised by a function for providing positioning integrity.

The TIR is configured by an LMF for a terminal. The AL and the TTA are determined by the terminal, for instance, acquired from a predetermined application. The terminal determines the PL according to the above inequality and reports the PL to the LMF.

Currently, only positioning integrity based on UE is standardized. Positioning integrity based on an LMF is introduced in the method provided in the disclosure. That is, the LMF determines the positioning integrity when the terminal is positioned.

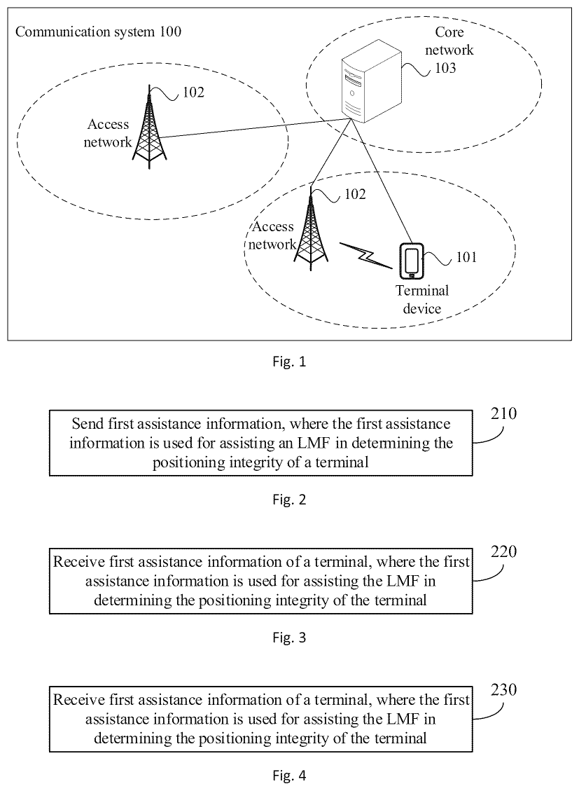

FIG. 1 is a schematic diagram of a communication system according to an example of the disclosure. The communication system 100 may include a terminal 101, an access network device 102, and a core network device 103.

A plurality of terminals 101 are generally arranged. One or more terminals 101 may be distributed in a cell managed by each access network device 102. The terminal 101 may include various handheld devices, vehicle-mounted devices, wearable devices, computing devices, and other processing devices connected to a wireless modem, where the devices have wireless communication functions, as well as various forms of user equipment (UEs), mobile stations (MSs), etc. For convenience of description, in examples of the disclosure, the above-mentioned devices are collectively referred to as terminals.

The access network device 102 may be a device deployed in an access network to provide a wireless communication function to the terminal 101. The access network devices 102 may include various forms of macro base stations, micro base stations, relay stations, and access points. In systems employing different radio access technologies, names of devices having access network device functions may be different. For instance, in an NR system of a 5th generation (5G) mobile communication technology, the devices are referred to as a next generation node B (gNodeB or gNB). As communication technologies evolve, the name “access network device” may change. For convenience of description, in examples of the disclosure, the above devices for providing a wireless communication function for the terminal 101 are collectively referred to as access network devices. A connection may be established between the access network device 102 and the terminal 101 through an air interface, such that communication is carried out through the connection, including interaction of signaling and data. A plurality of access network devices 102 may be arranged. Two adjacent access network devices 102 may be in communication with each other in a wired or wireless manner. The terminal 101 may carry out handover between different access network devices 102, that is, establish connections to different access network devices 102.

A core network device 103 is mainly used for providing user connections, manage users, and bear services, and serves as a bearer network to provide an interface to an external network. The access network device 102 and the core network device 103 may be collectively referred to as network devices. Illustratively, network devices in examples of the disclosure may refer to access network devices. The core network device 103 and the access network device 102 are in communication with each other through a technology. A communication relationship may be established between the terminal 101 and the core network device 103 by the access network device 102. Illustratively, the core network device in examples of the disclosure includes an LMF.

The “5G NR system” in examples of the disclosure may be referred to as a 5G system or an NR system, but a person skilled in the art can understand its meaning. The technical solutions described in examples of the disclosure may be applicable to a 5G NR system, and may also be applicable to an evolution system subsequent to the 5G NR system.

FIG. 2 shows a flow diagram of a method for determining positioning integrity according to an example of the disclosure. The method may be applied to a terminal. The method includes step 210.

Step 210: first assistance information is sent. The first assistance information is used for assisting an LMF in determining the positioning integrity of the terminal.

Positioning includes downlink positioning, uplink-downlink combined positioning, and uplink positioning. For instance, a positioning technology used for positioning includes but is not limited to positioning based on a downlink time difference of arrival (DL-TDOA), downlink angle-of-departure (DL-AOD), multiplecell-round trip time (multi-RTT), an uplink time difference of arrival (UL-TDOA), and uplink angles of arrival (UL-AOA).

In a case of the downlink positioning or the uplink-downlink combined positioning, the terminal sends the first assistance information to the LMF.

In a case of the uplink positioning, the terminal sends the first assistance information to the access network device. The access network device reports the first assistance information to the LMF.

In some examples, the first assistance information sent by the terminal to the LMF is carried in a long term evolution positioning protocol (LPP) message. For instance, the first assistance information is carried in LPP provide location information.

In some examples, the first assistance information sent by the terminal to the access network device is carried in a radio resource control (RRC) message.

In some examples, the positioning integrity includes at least one of:
a confidence level of accuracy of location information provided by a positioning system; or
a capability to send a valid warning in a case that the positioning system does not satisfy a predetermined operating condition.

The positioning system is a system for carrying out the above positioning, for instance, includes one or more of an LMF, a terminal, and a network device. The location information is information or data related to a location or position. In some examples, not satisfying the predetermined operating condition includes a protection level (PL) being greater than an alert limit (AL).

In some examples, the positioning integrity includes the PL. The PL includes the HPL and/or the VPL.

The positioning integrity is determined according to the first assistance information.

The first assistance information includes at least one of the PE, the TIR, the AL, or the TTA.

The PE includes positioning error distribution of the terminal device. An acquisition method and a data form of the PE are implemented by the terminal. For instance, the PE includes error distribution between a position obtained by the terminal device through the positioning system in a period of time and a true position. The terminal may update the PE according to a new positioning result. For another example, the terminal may acquire positioning error information of the terminal from an application server, so as to determine the PE of the terminal.

The TIR is a probability that the positioning error of the positioning system goes beyond the AL per unit time. The TIR may be configured by the LMF, may be determined by the terminal, or may be acquired by the terminal from the application server. For instance, if the terminal sends the TIR to the LMF, the terminal may acquire information from the application server to determine the TIR. For another example, in a case of positioning integrity based on UE, the LMF configures the TIR for the terminal, so as to indicate to the terminal that the probability that the positioning error of the positioning system goes beyond the AL per unit time should not go beyond the TIR.

The AL is a maximum allowable positioning error that enables a positioning system to be used for a predetermined application. The AL is the maximum allowable positioning error that enables the positioning system to be used for a predetermined application (an application corresponding to the application server). The AL is determined by the terminal, or the AL is acquired by the terminal from the application server. The application server is provided with the AL according to requirements of a predetermined application such that the positioning error of the positioning system is required to be less than the AL.

The TTA is the maximum allowable time from the time when the positioning error goes beyond the AL to the time when the positioning system raises an alarm. That is, the positioning system should raise an alarm within the TTA after the positioning error goes beyond the AL.

In some examples, the PL is determined by a first inequality. The first inequality includes a first probability being less than TIR. The first probability is a probability that the terminal simultaneously satisfies a first condition and a second condition for a time longer than the TTA. The first condition includes the PE being greater than the AL. The second condition includes the PL being less than or equal to the AL.

That is, the first inequality includes:
probability of [((PE>AL)&(PL<=AL)) longer than TTA] per unit time<required TIR.

The LMF determines, according to the first assistance information reported by the terminal, the PL of the positioning system when the terminal is positioned.

To sum up, according to the method provided in the example, the positioning integrity based on the LMF is introduced. The terminal reports the assistance information. The LMF determines the positioning integrity of the terminal based on the assistance information.

FIG. 3 shows a flow diagram of a method for determining positioning integrity according to an example of the disclosure. The method may be applied to the LMF. The method includes step 220.

Step 220: first assistance information of a terminal is received. The first assistance information is used for assisting the LMF in determining the positioning integrity of the terminal.

In a scenario of downlink positioning or uplink-downlink combined positioning, the LMF receives the first assistance information sent by the terminal.

In a scenario of uplink positioning, the LMF receives the first assistance information of the terminal sent by the access network device.

In some examples, the LMF receives the first assistance information by using a long term evolution positioning protocol (LPP) message. For instance, the first assistance information is carried in LPP provide location information. In some examples, the positioning integrity includes at least one of:
a confidence level of accuracy of location information provided by a positioning system; or
a capability to send a valid warning in a case that the positioning system does not satisfy a predetermined operating condition.

The positioning system is a system for carrying out the above positioning, for instance, includes one or more of an LMF, a terminal, and a network device. The location information is information or data related to a location or position. In some examples, not satisfying the predetermined operating condition includes a protection level (PL) being greater than an alert limit (AL).

In some examples, the positioning integrity includes the PL. The PL includes the HPL and/or the VPL.

The first assistance information includes at least one of the PE, the TIR, the AL, or the TTA.

The LMF determines positioning integrity of the terminal based on the first assistance information. If the positioning integrity does not satisfy predetermined requirements, the LMF should send an alarm to the terminal or the application server in time to inform that the positioning system is unreliable.

To sum up, according to the method provided in the example, the positioning integrity based on the LMF is introduced. The terminal reports the assistance information. The LMF determines the positioning integrity of the terminal based on the assistance information.

FIG. 4 shows a flow diagram of a method for determining positioning integrity according to an example of the disclosure. The method may be applied to an access network device. The method includes step 230.

Step 230: first assistance information of a terminal is received. The first assistance information is used for assisting the LMF in determining the positioning integrity of the terminal.

In a scenario of uplink positioning, the terminal sends the first assistance information to an access network device. The access network device sends the first assistance information to the LMF.

In some examples, the first assistance information sent by the access network device to the LMF is carried in an NR positioning protocol A (NRPPa) message. In some examples, the first assistance information sent by the terminal to the access network device is carried in a radio resource control (RRC) message.

In some examples, the positioning integrity includes at least one of:
a confidence level of accuracy of location information provided by a positioning system; or
a capability to send a valid warning in a case that the positioning system does not satisfy a predetermined operating condition.

The positioning system is a system for carrying out the above positioning, for instance, includes one or more of an LMF, a terminal, and a network device. The location information is information or data related to a location or position. In some examples, not satisfying the predetermined operating condition includes a protection level (PL) being greater than an alert limit (AL).

In some examples, the positioning integrity includes the PL. The PL includes the HPL and/or the VPL.

The first assistance information includes at least one of the PE, the TIR, the AL, or the TTA.

To sum up, according to the method provided in the example, the positioning integrity based on the LMF is introduced. The terminal reports the assistance information. The LMF determines the positioning integrity of the terminal based on the assistance information.

Illustratively, an example of positioning integrity based on an LMF in a scenario of downlink positioning or uplink-downlink combined positioning is provided.

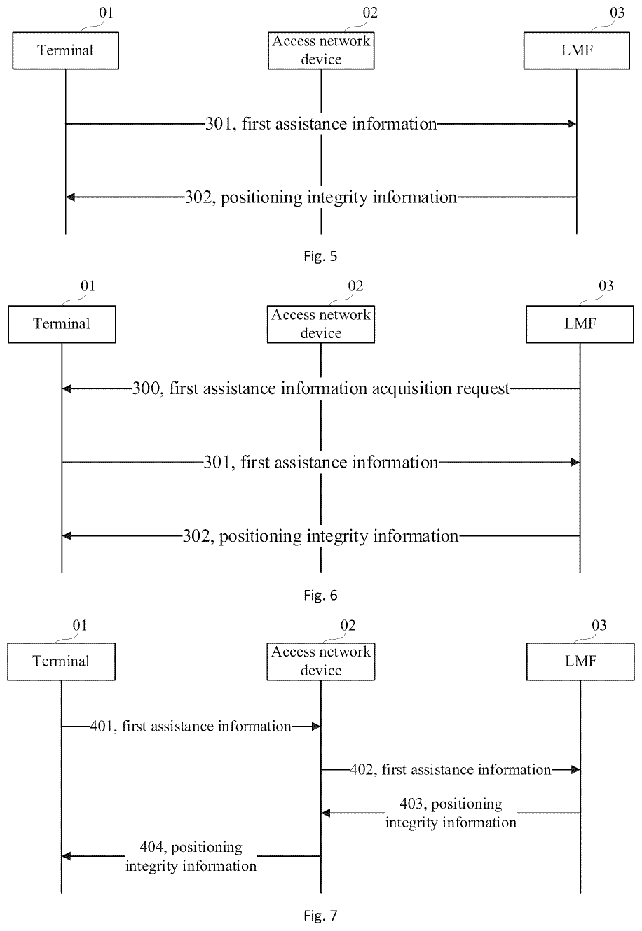

FIG. 5 shows a flow diagram of a method for determining positioning integrity according to an example of the disclosure. The method may be applied to the terminal 01, the access network device 02, and the LMF 03. The method includes the following steps 301-302.

Step 301: the terminal 01 sends the first assistance information to the LMF 03.

In a scenario of downlink positioning or uplink-downlink combined positioning, the terminal sends an LPP message to the LMF. The first assistance information is carried in the LPP message. The LMF receives the LPP message sent by the terminal.

In some examples, the positioning integrity includes at least one of:
a confidence level of accuracy of location information provided by a positioning system; or
a capability to send a valid warning in a case that the positioning system does not satisfy a predetermined operating condition.

The positioning system is a system for carrying out the above positioning, for instance, includes one or more of an LMF, a terminal, and a network device. The location information is information or data related to a location or position. In some examples, not satisfying the predetermined operating condition includes a protection level (PL) being greater than an alert limit (AL).

In some examples, the positioning integrity includes the PL. The PL includes the HPL and/or the VPL.

The first assistance information includes at least one of the PE, the TIR, the AL, or the TTA.

In some examples, the terminal may report the first assistance information to the LMF in response to an acquisition request of the LMF.

As shown in FIG. 6, before step 301, the method further includes step 300: the LMF 03 sends a first assistance information acquisition request to the terminal 01. The first assistance information acquisition request is used for requesting the terminal to report the first assistance information. In some examples, the LMF sends an acquisition request for the first assistance information by using LPP request location information. After receiving the first assistance information acquisition request, the terminal reports the first assistance information to the LMF.

The LMF determines positioning integrity of the terminal based on the first assistance information of the terminal. For instance, the LMF determines, based on the first assistance information of the terminal, the PL of the positioning system when the terminal is positioned.

Step 302: the LMF 03 sends positioning integrity information to the terminal 01.

The positioning integrity information includes at least one of: a PL or a completed TIR. The completed TIR is a TIR for determining the PL.

After determining the positioning integrity of the terminal, the LMF sends positioning integrity information to the terminal. For instance, the LMF may provide the PL (the HPL and/or the VPL) to the UE. Alternatively, the LMF may provide the completed TIR to the UE.

The completed TIR may be the TIR in the first assistance information. Alternatively, the completed TIR is distinguished from the TIR in the first assistance information. When the LMF may not compute the PL by using the TIR in the first assistance information, the LMF may determine a new TIR for computing the PL. The TIR used for computing the PL is the completed TIR.

For instance, if the TIR in the first assistance information is small and the LMF may not determine the PL which satisfies the inequality, the LMF can increase the TIR, and compute the PL by using the increased TIR. The TIR used for finally computing the PL is the completed TIR.

In some examples, the positioning integrity information is carried in the LPP message. That is, the LMF sends an LPP message to the terminal. The positioning integrity information is carried in the LPP message. The terminal receives the LPP message.

In an example, step 301 and step 302 each may be implemented as an example separately. For instance, the terminal may report the first assistance information to the LMF. However, the LMF may not send positioning integrity information to the terminal. For instance, the LMF sends only positioning integrity information to a positioning proxy. For another example, the terminal does not report the first assistance information to the LMF. The LMF may acquire relevant information from a positioning proxy or an external positioning application to determine the positioning integrity. Then, the LMF sends positioning integrity information to the terminal.

In some examples, when the terminal determines, according to the positioning integrity information, that the positioning system is inaccurate, the terminal device raises an alarm.

To sum up, according to the method provided in the example, in a scenario of downlink positioning or uplink-downlink combined positioning, the LMF determines positioning integrity of a terminal based on assistance information reported by the terminal, and sends the determined positioning integrity to the terminal. Thus, the terminal raises an alarm in time in a case that the positioning integrity does not satisfy a predetermined requirement.

Illustratively, an example of positioning integrity based on an LMF in a scenario of uplink positioning is provided.

FIG. 7 shows a flow diagram of a method for determining positioning integrity according to an example of the disclosure. The method may be applied to the terminal 01, the access network device 02, and the LMF 03. The method includes the following steps 401-404.

Step 401: the terminal 01 sends the first assistance information to an access network device 02.

In a scenario of uplink positioning, the terminal sends an RRC message to the access network device. The first assistance information is carried in the RRC message. The access network device receives the RRC message sent by the terminal.

In some examples, the positioning integrity includes at least one of:
a confidence level of accuracy of location information provided by a positioning system; or
a capability to send a valid warning in a case that the positioning system does not satisfy a predetermined operating condition.

The positioning system is a system for carrying out the above positioning, for instance, includes one or more of an LMF, a terminal, and a network device. The location information is information or data related to a location or position. In some examples, not satisfying the predetermined operating condition includes a protection level (PL) being greater than an alert limit (AL).

In some examples, the positioning integrity includes the PL. The PL includes the HPL and/or the VPL.

The first assistance information includes at least one of the PE, the TIR, the AL, or the TTA.

In some examples, the terminal may report the first assistance information to the access network device in response to an acquisition request of the access network device.

For instance, before step 401, the access network device sends a first assistance information acquisition request to the terminal. The first assistance information acquisition request is used for requesting the terminal to report the first assistance information. After receiving the first assistance information acquisition request, the terminal reports the first assistance information to the access network device.

In some examples, the access network device may send the first assistance information acquisition request to the terminal in response to the first assistance information acquisition request sent by the LMF. For instance, the access network device receives the first assistance information acquisition request sent by the LMF. Then, the access network device sends the first assistance information acquisition request to the terminal device.

In some examples, the first assistance information sent by the terminal to the LMF is carried in a long term evolution positioning protocol (LPP) message. For instance, the first assistance information is carried in LPP provide location information.

Step 402: the access network device 02 sends the first assistance information to the LMF 03.

The first assistance information sent by the access network device to the LMF is carried in an NRPPa message. The access network device sends an NRPPa message to the LMF. The first assistance information is carried in the NRPPa message. The LMF receives the NRPPa message.

The LMF determines the positioning integrity of the terminal based on the first assistance information sent by the access network device. For instance, the LMF determines, based on the first assistance information of the terminal, the PL of the positioning system when the terminal is positioned.

Step 403: the LMF 03 sends positioning integrity information to the access network device 02.

The positioning integrity information includes at least one of: a PL or a completed TIR. The completed TIR is a TIR for determining the PL.

After determining the positioning integrity of the terminal, the LMF sends positioning integrity information to the access network device. For instance, an LMF may provide the PL (the HPL and/or the VPL) to the access network device. Alternatively, the LMF provides the completed TIR for the access network device.

In some examples, the positioning integrity information is carried in the NRPPa message. That is, the LMF sends the NRPPa message to the access network device. The positioning integrity information is carried in the NRPPa message. The access network device receives the LPP message.

Step 404: the access network device 02 sends positioning integrity information to the terminal 01.

In some examples, the positioning integrity information is carried in the RRC message. That is, the access network device sends the RRC message to the terminal. The positioning integrity information is carried in the RRC message. The terminal receives the RRC message.

In some examples, each step in the example may be implemented as an example separately, or any steps in the example may be combined such that a new example can be obtained. For instance, step 401, step 402, and step 403 are combined, such that a new example is obtained. That is, after receiving the positioning integrity information, the access network device does not send the positioning integrity information to the UE. For another example, step 401 and step 402 are combined, such that a new example is obtained. That is, the gNB acquires information from the UE and sends the information to the LMF. After determining the positioning integrity information, the LMF does not send the information to the gNB. In some examples, the LMF sends the positioning integrity information to the positioning proxy.

In some examples, when the terminal determines, according to the positioning integrity information, that the positioning system is inaccurate, the terminal device raises an alarm.

To sum up, according to the method provided in the example, in a scenario of uplink positioning, the LMF determines positioning integrity of a terminal based on assistance information reported by the terminal, and sends the determined positioning integrity to the terminal. Thus, the terminal raises an alarm in time in a case that the positioning integrity does not satisfy a predetermined requirement.

For instance, before reporting the first assistance information, the terminal may further report the positioning integrity capability.

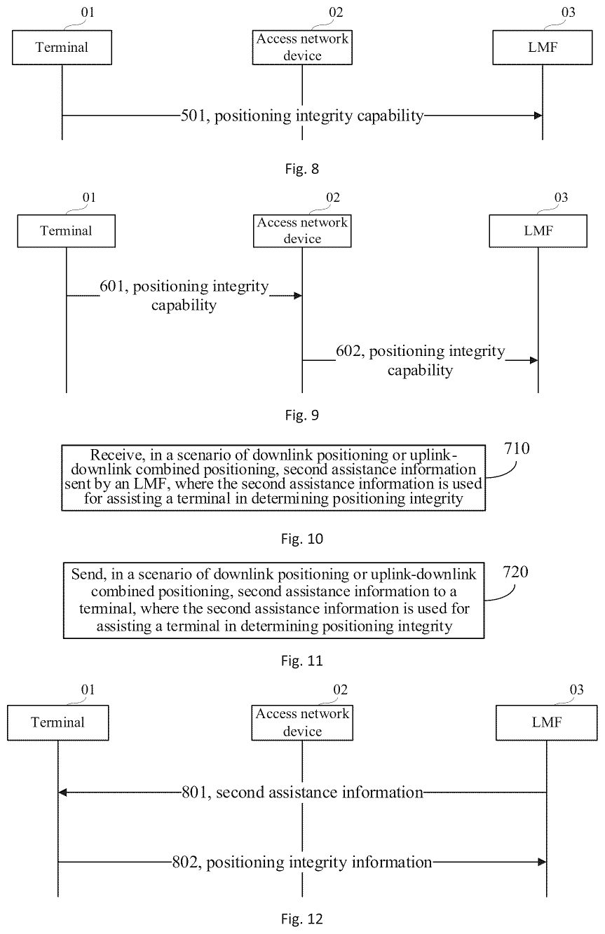

FIG. 8 shows a flow diagram of a method for determining positioning integrity according to an example of the disclosure. The method may be applied to the terminal 01, the access network device 02, and the LMF 03. The method includes step 501.

Step 501: the terminal 01 sends a positioning integrity capability to the LMF 03.

The positioning integrity capability includes whether the terminal supports a positioning integrity function based on at least one positioning technology.

The UE indicates to the LMF that a positioning integrity capability based on a positioning technology is supported, for instance, based on a positioning technology of a DL-TDOA, based on a positioning technology of a DL-AOD, based on a positioning technology of multi-RTT, based on a positioning technology of a UL-TDOA, and based on a positioning technology of UL-AOA.

For instance, the terminal reports to the LMF that the positioning integrity function based on a positioning technology of a DL-TDOA is supported. Then, when configuring the positioning system to use a positioning technology of a DL-TDOA, the LMF may request the terminal to report the first assistance information.

The positioning integrity capability is carried in the LPP message. For instance, the terminal sends an LPP message to the LMF. The LPP message includes the positioning integrity capability of the terminal. The LMF receives the LPP message.

In some examples, before step 501, the LMF may further send a capability acquisition request to the terminal. The terminal reports the positioning integrity capability to the LMF in response to the capability acquisition request.

FIG. 9 shows a flow diagram of a method for determining positioning integrity according to an example of the disclosure. The method may be applied to the terminal 01, the access network device 02, and the LMF 03. The method includes the following steps 601-602.

Step 601: the terminal 01 sends the positioning integrity capability to the access network device 02.

The positioning integrity capability includes whether the terminal supports a positioning integrity function based on at least one positioning technology.

The UE indicates to an access network device that a positioning integrity capability based on a positioning technology is supported, for instance, based on a positioning technology of a DL-TDOA, based on a positioning technology of a DL-AOD, based on a positioning technology of multi-RTT, based on a positioning technology of a UL-TDOA, and based on a positioning technology of UL-AOA.

For instance, the terminal reports to the access network device that the positioning integrity function based on a positioning technology of a DL-TDOA is supported. The access network device may request the terminal to report the first assistance information.

The positioning integrity capability is carried in the RRC message. For instance, the terminal sends an RRC message to the access network device. The RRC message includes the positioning integrity capability of the terminal.

In some examples, before step 601, the access network device may further send a capability acquisition request to the terminal. The terminal reports the positioning integrity capability to the access network device in response to the capability acquisition request.

Step 602: the access network device 02 sends the positioning integrity capability of the terminal 01 to the LMF 03.

The access network device reports the positioning integrity capability of the terminal to the LMF.

The positioning integrity capability is carried in an NRPPa message. For instance, the access network device sends an NRPPa message to the LMF. The NRPPa message includes the positioning integrity capability of the terminal. The LMF receives the NRPPa message.

In some examples, step 601 and step 602 each may be implemented as an example separately. For instance, only step 601 is included. That is, the access network device does not send the positioning integrity capability of the terminal to the LMF.

The methods shown in FIG. 8 and FIG. 9 may be combined with the examples shown in FIG. 5, FIG. 6, and FIG. 7 such that a new example can be obtained. For instance, before step 301 in FIG. 5, step 501 in FIG. 8 is executed to report the positioning integrity capability of the terminal to the LMF.

For another example, before step 300 in FIG. 6, step 501 in FIG. 8 is executed to report the positioning integrity capability of the terminal to the LMF.

For another example, before step 401 in FIG. 7, step 601 and/or step 602 in FIG. 9 are executed to report the positioning integrity capability of the terminal.

To sum up, according to the method provided in the example, a method for reporting a positioning integrity capability of a terminal is provided to enable an LMF to execute, based on the positioning integrity capability of the terminal, a method for determining positioning integrity based on the LMF.

Illustratively, an example of the disclosure further provides a method for determining positioning integrity based on the UE. An LMF provides second assistance information to the UE.

FIG. 10 shows a flow diagram of a method for determining positioning integrity according to an example of the disclosure. The method may be applied to a terminal. The method includes step 710.

Step 710: in a scenario of downlink positioning or uplink-downlink combined positioning, second assistance information sent by an LMF is received. The second assistance information is used for assisting the terminal in determining the positioning integrity.

In a case of the downlink positioning or the uplink-downlink combined positioning, the LMF sends second assistance information to the terminal.

In some examples, the second assistance information sent by the LMF to the terminal is carried in the LPP message. For instance, the first assistance information is carried in LPP provide location information.

In some examples, the positioning integrity includes at least one of:
a confidence level of accuracy of location information provided by a positioning system; or
a capability to send a valid warning in a case that the positioning system does not satisfy a predetermined operating condition.

The positioning system is a system for carrying out the above positioning, for instance, includes one or more of an LMF, a terminal, and a network device. The location information is information or data related to a location or position. In some examples, not satisfying the predetermined operating condition includes a protection level (PL) being greater than an alert limit (AL).

In some examples, the positioning integrity includes the PL. The PL includes the HPL and/or the VPL.

The positioning integrity is determined according to the second assistance information. The second assistance information is configured by the LMF.

The second assistance information includes at least one of the PE, the TIR, the AL, or the TTA.

The PE includes positioning error distribution of the terminal device. For instance, the PE includes error distribution between a position obtained by the terminal device through the positioning system in a period of time and a true position. The LMF may acquire the PE of the terminal from the application server. The PE of the terminal is stored in the application server.

The TIR is a probability that the positioning error of the positioning system goes beyond the AL per unit time. The TIR is configured by the LMF. In some examples, the LMF may acquire the TIR from the application server. In some examples, the LMF may configure the TIR for the terminal.

The AL is a maximum allowable positioning error that enables a positioning system to be used for a predetermined application. The AL is the maximum allowable positioning error that enables the positioning system to be used for a predetermined application (an application corresponding to the application server). The AL is configured by the LMF. Alternatively, the AL is acquired by the LMF from the application server and configured to the terminal.

The TTA is the maximum allowable time from the time when the positioning error goes beyond the AL to the time when the positioning system raises an alarm. That is, the positioning system should raise an alarm within the TTA after the positioning error goes beyond the AL. The TTA is configured by the LMF. Alternatively, the TTA is acquired by the LMF from the application server and configured to the terminal.

In some examples, the PL is determined by using a first inequality. The first inequality includes a first probability being less than TIR. The first probability is a probability that the terminal simultaneously satisfies a first condition and a second condition for a time longer than the TTA. The first condition includes the PE being greater than the AL. The second condition includes the PL being less than or equal to the AL.

That is, the first inequality includes:
probability of [((PE>AL)&(PL<=AL)) longer than TTA] per unit time<required TIR.

The terminal determines, according to the second assistance information configured by the LMF, the PL of the positioning system when the terminal is positioned. If the positioning integrity does not satisfy a predetermined requirement, the terminal or the application server should send an alarm in time to inform that the positioning system is unreliable.

To sum up, according to the method provided in the example, the LMF is enabled to configure the PE, the TIR, the AL, or the TTA for the terminal, and the terminal device is enabled to determine positioning integrity based on a configuration of the LMF.

FIG. 11 shows a flow diagram of a method for determining positioning integrity according to an example of the disclosure. The method may be applied to the LMF. The method includes step 720.

Step 720: in a scenario of downlink positioning or uplink-downlink combined positioning, second assistance information is sent to a terminal. The second assistance information is used for assisting the terminal in determining the positioning integrity.

In a scenario of downlink positioning or uplink-downlink combined positioning, the LMF sends the second assistance information to the terminal.

In some examples, the positioning integrity includes at least one of:
a confidence level of accuracy of location information provided by a positioning system; or
a capability to send a valid warning in a case that the positioning system does not satisfy a predetermined operating condition.

The positioning system is a system for carrying out the above positioning, for instance, includes one or more of an LMF, a terminal, and a network device. The location information is information or data related to a location or position. In some examples, not satisfying the predetermined operating condition includes a protection level (PL) being greater than an alert limit (AL).

In some examples, the positioning integrity includes the PL. The PL includes the HPL and/or the VPL.

The positioning integrity is determined according to the second assistance information. The second assistance information is configured by the LMF.

The second assistance information includes at least one of the PE, the TIR, the AL, or the TTA.

To sum up, according to the method provided in the example, the LMF is enabled to configure the PE, the TIR, the AL, or the TTA for the terminal, and the terminal device is enabled to determine positioning integrity based on a configuration of the LMF.

Illustratively, an example of positioning integrity based on UE in a scenario of downlink positioning or uplink-downlink combined positioning is provided.

FIG. 12 shows a flow diagram of a method for determining positioning integrity according to an example of the disclosure. The method may be applied to the terminal 01, the access network device 02, and the LMF 03. The method includes the following steps 801-802.

Step 801: an LMF 03 sends the second assistance information to the terminal 01.

In a scenario of downlink positioning or uplink-downlink combined positioning, the LMF sends an LPP message to the terminal. The second assistance information is carried in the LPP message. The terminal receives the LPP message sent by the LMF.

In some examples, the positioning integrity includes at least one of:
a confidence level of accuracy of location information provided by a positioning system; or
a capability to send a valid warning in a case that the positioning system does not satisfy a predetermined operating condition.

The positioning system is a system for carrying out the above positioning, for instance, includes one or more of an LMF, a terminal, and a network device. The location information is information or data related to a location or position. In some examples, not satisfying the predetermined operating condition includes a protection level (PL) being greater than an alert limit (AL).

In some examples, the positioning integrity includes the PL. The PL includes the HPL and/or the VPL.

The positioning integrity is determined according to the second assistance information. The second assistance information is configured by the LMF.

The second assistance information includes at least one of the PE, the TIR, the AL, or the TTA.

The terminal determines the positioning integrity based on the second assistance information. For instance, the terminal determines, based on the second assistance information, the PL of the positioning system when the terminal is positioned.

Step 802: the terminal 01 sends positioning integrity information to the LMF 03.

The positioning integrity information includes at least one of: a PL or a completed TIR. The completed TIR is a TIR for determining the PL.

After determining the positioning integrity, the terminal sends positioning integrity information to the LMF. For instance, the terminal may provide the PL (the HPL and/or the VPL) to the LMF. Alternatively, the terminal may provide the completed TIR to the LMF.

The completed TIR may be the TIR in the second assistance information. Alternatively, the completed TIR is distinguished from the TIR in the second assistance information. When the terminal may not compute the PL by using the TIR in the second assistance information, the terminal may determine a new TIR for computing the PL. The TIR used for computing the PL is the completed TIR. Alternatively, the terminal may acquire a TIR from the application server, and compute the PL by using the TIR acquired from the application server. The completed TIR is the TIR acquired from the application server.

In some examples, the positioning integrity information is carried in the LPP message. That is, the terminal sends an LPP message to the LMF. The positioning integrity information is carried in the LPP message. The LMF receives the LPP message.

In an example, step 801 and step 802 each may be implemented as an example separately. For instance, the LMF may configure the second assistance information for the terminal. However, the terminal may not send the positioning integrity information to the LMF.

In some examples, when the terminal determines, according to the positioning integrity information, that the positioning system is inaccurate, the terminal device raises an alarm.

To sum up, according to the method provided in the example, in a scenario of downlink positioning or uplink-downlink combined positioning, the terminal determines positioning integrity of a terminal based on assistance information reported by the LMF, and sends the determined positioning integrity to the LMF. Thus, the terminal raises an alarm in time in a case that the positioning integrity does not satisfy a predetermined requirement.

Illustratively, four examples are further provided.

### Example 1

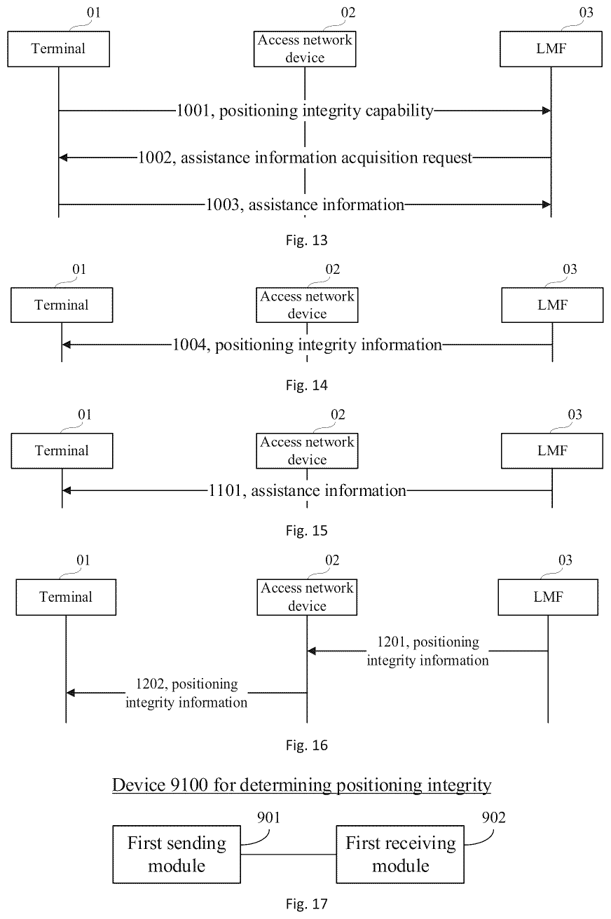

FIG. 13 shows a flow diagram of a method for determining positioning integrity according to an example of the disclosure. The method may be applied to the terminal 01, the access network device 02, and the LMF 03. The method includes the following steps 1001-1003 and points 1-4.

Step 1001: the terminal 01 sends the positioning integrity capability to the LMF 03.

Step 1002: the LMF 03 sends an assistance information acquisition request (a first assistance information acquisition request) to the terminal 01.

Step 1003: the terminal 01 sends assistance information (first assistance information) to the LMF 03.
1. In a case of downlink positioning, based on the positioning integrity of the LMF, the UE provides at least one of the following information (assistance information/first assistance information) to the LMF:
a·positioning error;
a target integrity risk;
an alert limit, including a horizontal alert limit and a vertical alert limit; or time-to-alert.
2. The UE provides the above information (assistance information/first assistance information) to the LMF by using an LPP message, for instance, by using an LPP provide location information message.
3. Based on a request (assistance information acquisition request) of the LMF, the UE sends the information (assistance information/first assistance information) to the LMF.
4. The UE indicates to the LMF that the positioning integrity capability based on a positioning technology, such as a DL-TDOA, a DL-AOD, multi-RTT, an UL-TDOA, and UL-AOA, is supported.

To sum up, according to the method provided in the example, in a scenario of downlink positioning or uplink-downlink combined positioning, the LMF determines positioning integrity of a terminal based on assistance information reported by the terminal. Thus, the positioning integrity based on the LMF is realized.

### Example 2

FIG. 14 shows a flow diagram of a method for determining positioning integrity according to an example of the disclosure. The method may be applied to the terminal 01, the access network device 02, and the LMF 03. The method includes the following step 1004 and points 1-2.

Step 1004: the LMF 03 sends positioning integrity information to the terminal 01.
1. In a case of downlink positioning, based on the positioning integrity of the LMF, the LMF provides at least one of the following information (positioning integrity information) to the UE:
a protection level, including a horizontal protection level and a vertical protection level; or
a completed target integrity risk.
2. The LMF provides the above information (positioning integrity information) to the UE by using an LPP message.

It should be noted that Example 1 and Example 2 may be combined. An example obtained after combination includes step 1001 to step 1004.

To sum up, according to the method provided in the example, the LMF sends the determined positioning integrity to the terminal. Thus, the terminal raises an alarm in time in a case that the positioning integrity does not satisfy a predetermined requirement.

### Example 3

FIG. 15 shows a flow diagram of a method for determining positioning integrity according to an example of the disclosure. The method may be applied to the terminal 01, the access network device 02, and the LMF 03. The method includes the following steps 1101 and points 1-2.

Step 1101: the LMF 03 sends assistance information (second assistance information) to the terminal 01.
1. In a case of downlink positioning, based on the positioning integrity of the UE, the LMF provides at least one of the following information (assistance information/second assistance information) to the UE:
a·positioning error;
an alert limit, including a horizontal alert limit and a vertical alert limit; or
time-to-alert.
2. The LMF provides the above information (assistance information/second assistance information) to the UE by using an LPP message, for instance, by using an LPP request location information message.

To sum up, according to the method provided in the example, the LMF is enabled to configure the PE, the TIR, the AL, or the TTA for the terminal, and the terminal device is enabled to determine positioning integrity based on a configuration of the LMF.

### Example 4

FIG. 16 shows a flow diagram of a method for determining positioning integrity according to an example of the disclosure. The method may be applied to the terminal 01, the access network device 02, and the LMF 03. The method includes the following steps 1201-1202 and points 1-3.

Step 1201: the LMF 03 sends positioning integrity information to an access network device 02.

Step 1202: the access network device 02 sends positioning integrity information to the terminal 01.
1. In a case of an uplink positioning technology, the LMF provides at least one of the following information (positioning integrity information) to the gNB:
a protection level, including a horizontal protection level and a vertical protection level; or
a completed target integrity risk.
2. The LMF sends the information (positioning integrity information) to the gNB by using an NRPPa message.
3. The gNB sends the information (positioning integrity information) to the UE, for instance, sends the information to the UE by using the RRC message.

To sum up, according to the method provided in the example, in a scenario of uplink positioning, the LMF sends the determined positioning integrity to a base station. The base station sends the determined positioning integrity to the terminal. Thus, the terminal raises an alarm in time in a case that the positioning integrity does not satisfy a predetermined requirement.

It should be noted that a sequence of steps of the method provided in an example of the disclosure may be appropriately adjusted. The steps may be increased or decreased accordingly according to circumstances. Different steps may be freely combined to form new examples. Methods of which changes can readily occur to those skilled in the art within the scope of technology disclosed in the disclosure should all fall within the scope of protection of the disclosure, and thus will not be repeated.

FIG. 17 shows a structural block diagram of a device 9100 for determining positioning integrity according to an example of the disclosure. As shown in FIG. 17, the device 9100includes first sending module 901 and first receiving module 902.
a first sending module 901 used for sending first assistance information. The first assistance information is used for assisting a location management function (LMF) in determining the positioning integrity of a terminal.

In an example, the positioning integrity includes at least one of:
a confidence level of accuracy of location information provided by a positioning system; or
a capability to send a valid warning in a case that the positioning system does not satisfy a predetermined operating condition.

In an example, the positioning integrity includes a protection level (PL).

In an example, the first assistance information includes at least one of:
a positioning error (PE);
a target integrity risk (TIR);
an alert limit (AL); or
time-to-alert (TTA).

In an example, the first sending module 901 is used for sending the first assistance information to the LMF in a scenario of downlink positioning or uplink-downlink combined positioning.

In an example, the device 9100 further includes:
a first receiving module 902 used for receiving a first assistance information acquisition request sent by the LMF. The first assistance information acquisition request is used for requesting the terminal to report the first assistance information.

In an example, the device 9100 further includes:
a first receiving module 902 used for receiving positioning integrity information sent by the LMF.

The positioning integrity information includes at least one of: a PL or a completed TIR. The completed TIR is a TIR for determining the PL.

In an example, the first sending module 901 is used for sending the first assistance information to an access network device in a scenario of uplink positioning.

In an example, the device 9100 further includes:
a first receiving module 902 used for receiving positioning integrity information sent by the access network device.

The positioning integrity information includes at least one of: a PL or a completed TIR; and the completed TIR is a TIR for determining the PL.

In an example, the first sending module 901 is used for sending a positioning integrity capability to the LMF.

The positioning integrity capability includes whether the terminal supports a positioning integrity function based on at least one positioning technology.

In an example, the device 9100 further includes:
a first receiving module 902 used for sending the positioning integrity capability to the access network device.

The positioning integrity capability includes whether the terminal supports a positioning integrity function based on at least one positioning technology.

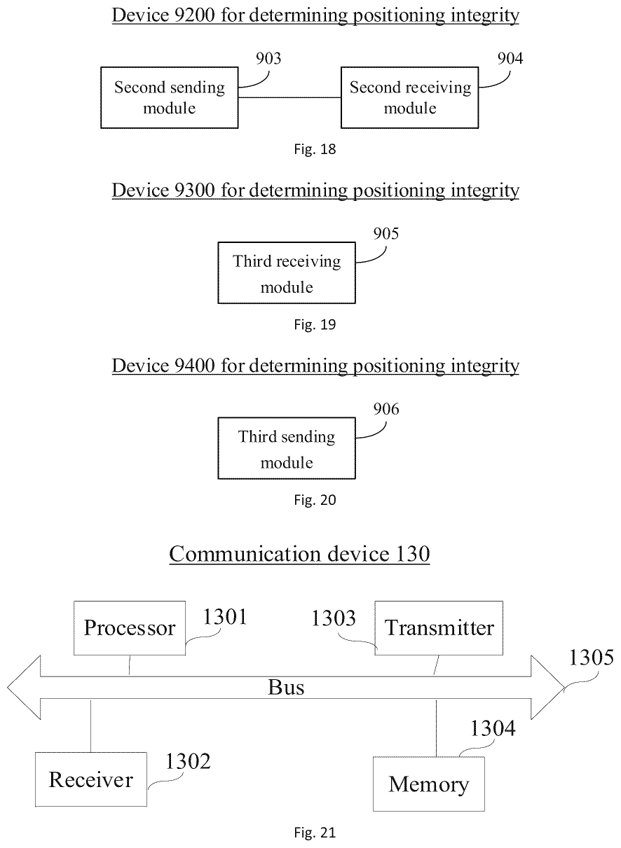

FIG. 18 shows a structural block diagram of a device 9200 for determining positioning integrity according to an example of the disclosure. As shown in FIG. 18, the device 9200 includes second sending module 903 and second receiving module 904.
a second receiving module 904 used for receiving first assistance information of a terminal. The first assistance information is used for assisting the LMF in determining the positioning integrity of the terminal.

In an example, the positioning integrity includes at least one of:
a confidence level of accuracy of location information provided by a positioning system; or
a capability to send a valid warning in a case that the positioning system does not satisfy a predetermined operating condition.

In an example, the positioning integrity includes a protection level (PL).

In an example, the first assistance information includes at least one of:
a positioning error (PE);
a target integrity risk (TIR);
an alert limit (AL); or
time-to-alert (TTA).

In an example, the second receiving module 904 is used for receiving, in a case that the device 9200 is applied to the LMF and in a scenario of downlink positioning or uplink-downlink combined positioning, the first assistance information sent by the terminal; and receive, in a case that the device 9200 is applied to the access network device and in a scenario of uplink positioning, the first assistance information sent by the terminal. In an example, the device 9200 further includes:
a second sending module 903 used for sending, in a case that the device 9200 is applied to the LMF, a first assistance information acquisition request to the terminal, where the first assistance information acquisition request is used for requesting the terminal to report the first assistance information; and
send, in a case that the device 9200 is applied to the access network device, the first assistance information of the terminal to the LMF.

In an example, the device 9200 further includes:
a second sending module 903 used for sending, in a case that the device 9200 is applied to the LMF, positioning integrity information to the terminal; and
receive, in a case that the device 9200 is applied to the access network device, positioning integrity information sent by the LMF.

The positioning integrity information includes at least one of: a PL or a completed TIR. The completed TIR is a TIR for determining the PL.

In an example, the second receiving module 904 is used for receiving, in a case that the device9200 is applied to the LMF and in a scenario of uplink positioning, the first assistance information of the terminal sent by the access network device. In an example, the device 9200 further includes a second sending module 903 used for sending, in a case that the device 9200 is applied to the access network device, positioning integrity information to the terminal.

In an example, the device 9200 further includes:
a second sending module 903 used for sending positioning integrity information to the access network device.

The positioning integrity information includes at least one of: a PL or a completed TIR. The completed TIR is a TIR for determining the PL.

In an example, the second receiving module 904 is used for receiving the positioning integrity capability sent by the terminal.

The positioning integrity capability includes whether the terminal supports a positioning integrity function based on at least one positioning technology.

In an example, the second receiving module 904 is used for receiving, in a case that the device 9200 is applied to an LMF, the positioning integrity capability of the terminal sent by the access network device.

The positioning integrity capability includes whether the terminal supports a positioning integrity function based on at least one positioning technology.

FIG. 19 shows a structural block diagram of a device 9300 for determining positioning integrity according to an example of the disclosure. As shown in FIG. 19, the device 9300 includes third receiving module 905.
a third receiving module 905 used for receiving, in a scenario of downlink positioning or uplink-downlink combined positioning, second assistance information sent by an LMF. The second assistance information is used for assisting the terminal in determining the positioning integrity.

In an example, the positioning integrity includes at least one of:
a confidence level of accuracy of location information provided by a positioning system; or
a capability to send a valid warning in a case that the positioning system does not satisfy a predetermined operating condition.

In an example, the positioning integrity includes a protection level (PL).

In an example, the second assistance information includes at least one of:
a positioning error (PE);
a target integrity risk (TIR);
an alert limit (AL); or
time-to-alert (TTA).

FIG. 20 shows a structural block diagram of a device 9400 for determining positioning integrity according to an example of the disclosure. As shown in FIG. 20, the device 9400 includes third sending module 906.
a third sending module 906 used for sending, in a scenario of downlink positioning or uplink-downlink combined positioning, second assistance information to a terminal. The second assistance information is used for assisting the terminal in determining the positioning integrity.

In an example, the positioning integrity includes at least one of:
a confidence level of accuracy of location information provided by a positioning system; or
a capability to send a valid warning in a case that the positioning system does not satisfy a predetermined operating condition.

In an example, the positioning integrity includes a protection level (PL).

In an example, the second assistance information includes at least one of:
a positioning error (PE);
a target integrity risk (TIR);
an alert limit (AL); or
time-to-alert (TTA).

It should be noted that when the devices 9100-9400 provided in the above examples implements its functions, division of the above functional modules is taken as an instance for description. During actual application, the above functions may be allocated to different functional modules for completion according to actual requirements. That is, content structures of the device are divided into different functional modules to complete all or some of the functions described above.

A specific method for executing an operation by each module of the devices 9100-9400 in the above examples is described in detail in examples related to the method, and will not be repeated here.

FIG. 21 shows a schematic structural diagram of a communication device according to an example of the disclosure. The communication device 130 includes: a processor 1301, a receiver 1302, a transmitter 1303, a memory 1304, and a bus 1305.

The processor 1301 includes one or more processing cores. The processor 1301 runs software programs and modules to execute various function applications and information processing.

The receiver 1302 and transmitter 1303 may be realized as a communication component, and the communication component may be a communication chip.

The memory 1304 is connected to the processor 1301 by means of the bus 1305.

The memory 1304 may be used for storing at least one instruction, and the processor 1301 is used for executing the at least one instruction, so as to implement the various steps of the above method examples.

The memory 1304 may be implemented by any type of volatile or non-volatile memory devices or their combinations. The volatile or non-volatile memory devices include but are not limited to a magnetic disk or an optical disk, an electrically-erasable programmable read-only memory (EEPROM), an erasable programmable read only memory (EPROM), a static random access memory (SRAM), a read-only memory (ROM), a magnetic memory, a flash memory, and a programmable read-only memory (PROM).

In a case that the communication device is implemented as a terminal, the processor and the transceiver of the communication device involved in examples of the disclosure may be implemented together as a communication chip, or the transceiver may form a communication chip separately. The transmitter of the transceiver executes the sending step executed by the terminal in any one of the methods shown above. The receiver of the transceiver executes the receiving step executed by the terminal in any one of the methods shown above. The processor executes the steps other than the sending and receiving steps, which will not be repeated here.

In a case that the communication device is implemented as an LMF, the processor and the transceiver of the communication device involved in examples of the disclosure may be implemented together as a communication chip, or the transceiver may form a communication chip separately. The transmitter of the transceiver executes the sending step executed by the LMF in any one of the methods shown above. The receiver of the transceiver executes the receiving step executed by the LMF in any one of the methods shown above. The processor executes the steps other than the sending and receiving steps, which will not be repeated here.

In a case that the communication device is implemented as an access network device, the processor and the transceiver of the communication device involved in examples of the disclosure may be implemented together as a communication chip, or the transceiver may form a communication chip separately. The transmitter of the transceiver executes the sending step executed by the access network device in any one of the methods shown above. The receiver of the transceiver executes the receiving step executed by the access network device in any one of the methods shown above. The processor executes the steps other than the sending and receiving steps, which will not be repeated here.

In an example, a non-transitory computer-readable storage medium is further provided. The non-transitory computer-readable storage medium stores at least one instruction, at least one program, a code set, or an instruction set. The at least one instruction, the at least one program, the code set, or the instruction set are loaded and executed by the processor, so as to implement the method for activating or deactivating an uplink positioning reference signal provided by each of the above method examples.

In an example, a chip is further provided. The chip includes a programmable logic circuit and/or a program instruction. The chip is run on a communication device to implement the method for activating or deactivating an uplink positioning reference signal provided by each of the above method examples.

In an example, a computer program product is further provided. The computer program product is run on a processor of a computer device to cause the computer device to execute the method for activating or deactivating an uplink positioning reference signal described above.

The technical solutions provided in the disclosure include beneficial effects at least as follows:
the positioning integrity based on the LMF is introduced. The terminal reports the assistance information. The LMF determines the positioning integrity of the terminal based on the assistance information.

Those skilled in the art should note that in one or more of the above instances, the functions described in examples of the disclosure may be implemented by hardware, software, firmware, or their combinations. In a case that the functions are implemented by software, the functions may be stored in a computer-readable medium or serve as one or more instructions or code on the computer-readable medium for transport. The computer-readable medium includes a computer storage medium and a communication medium. The communication medium includes any medium which can conveniently transfer a computer program from one place to another. The storage medium may be any available medium which can be accessed by a general-purpose or special-purpose computer.

The above descriptions are merely examples of the disclosure, and do not intend to limit the disclosure. Any modifications, equivalent substitutions, improvements, etc. made within the spirit and principles of the disclosure should all fall within the scope of protection of the disclosure.

1. A method for determining positioning integrity, performed by a terminal, the method comprising:
sending first assistance information, wherein the first assistance information is configured to assist a location management function (LMF) in determining the positioning integrity of the terminal.

2. The method according to claim 1, wherein the first assistance information comprises at least one of the following:
a positioning error (PE);
a target integrity risk (TIR);
an alert limit (AL); or
time-to-alert (TTA).

3. The method according to claim 1, wherein sending the first assistance information comprises:
sending the first assistance information to the LMF in a scenario of downlink positioning or uplink-downlink combined positioning.

4. The method according to claim 3, wherein the method further comprises:
receiving a first assistance information acquisition request sent by the LMF, wherein the first assistance information acquisition request is configured to request the terminal to report the first assistance information; or
receiving positioning integrity information sent by the LMF; wherein
the positioning integrity information comprises at least one of the following: a protection level (PL) or a completed TIR; and the completed TIR is a TIR for determining the PL.

5. (canceled)

6. The method according to claim 1,wherein sending the first assistance information comprises:
sending the first assistance information to an access network device in a scenario of uplink positioning; and the method further comprises:
receiving positioning integrity information sent by the access network device; wherein
the positioning integrity information comprises at least one of the following: a PL or a completed TIR; and the completed TIR is a TIR for determining the PL.

7. (canceled)

8. The method according to claim 1, wherein the method further comprises:
sending a positioning integrity capability to the LMF; wherein
the positioning integrity capability comprises whether the terminal supports a positioning integrity function based on at least one positioning technology; or
sending the positioning integrity capability to an access network device; wherein
the positioning integrity capability comprises whether the terminal supports a positioning integrity function based on at least one positioning technology.

9. (canceled)

10. A method for determining positioning integrity, performed by a location management function (LMF) or an access network device, the method comprising:
receiving first assistance information of a terminal, wherein the first assistance information is configured to assist the LMF in determining the positioning integrity of the terminal.

11. The method according to claim 10, wherein the first assistance information comprises at least one of the following:
a positioning error (PE);
a target integrity risk (TIR);
an alert limit (AL); or
time-to-alert (TTA).

12. The method according to claim 10, or wherein receiving the first assistance information of the terminal comprises:
receiving, in a case that the method is performed by the LMF and in a scenario of downlink positioning or uplink-downlink combined positioning, the first assistance information sent by the terminal; or
receiving, in a case that the method is performed by the access network device and in a scenario of uplink positioning, the first assistance information sent by the terminal.

13. The method according to claim 12, wherein the method further comprises:
sending, in the case that the method is performed by the LMF, a first assistance information acquisition request to the terminal, wherein the first assistance information acquisition request is configured to request the terminal to report the first assistance information; or
sending, in the case that the method is performed by the access network device, the first assistance information of the terminal to the LMF.

14. The method according to claim 12, wherein the method further comprises:
sending, in the case that the method is performed by the LMF, positioning integrity information to the terminal; or
receiving, in the case that the method is performed by the access network device, positioning integrity information sent by the LMF, and sending the positioning integrity information to the terminal; wherein
the positioning integrity information comprises at least one of: a protection level (PL) or a completed TIR; and the completed TIR is a TIR for determining the PL.

15. The method according to claim 10, wherein receiving the first assistance information of the terminal comprises:
receiving, in a case that the method is performed by the LMF, and in a scenario of uplink positioning, the first assistance information of the terminal sent by the access network device.

16. The method according to claim 15, wherein the method further comprises:
sending positioning integrity information to the access network device; wherein
the positioning integrity information comprises at least one of: a PL or a completed TIR; and the completed TIR is a TIR for determining the PL.

17. (canceled)

18. The method according to claim 10, wherein the method further comprises:
receiving a positioning integrity capability sent by the terminal; or
receiving, in a case that the method is performed by the LMF, a positioning integrity capability of the terminal sent by the access network device; wherein
the positioning integrity capability comprises whether the terminal supports a positioning integrity function based on at least one positioning technology.

19. The method according to claim 10, wherein the method further comprises:
receiving, in a case that the method is performed by the LMF a positioning integrity capability of the terminal sent by the access network device; wherein
the positioning integrity capability comprises whether the terminal supports a positioning integrity function based on at least one positioning technology.

20. The method according to claim 1, wherein the method further comprises:
receiving, in a scenario of downlink positioning or uplink-downlink combined positioning, second assistance information sent by an LMF, wherein the second assistance information is used for assisting the terminal in determining the positioning integrity, and the second assistance information comprises at least one of: a position error (PE), a target integrity risk (TIR), an alert limit (AL), or time-to-alert (TTA).

21. (canceled)

22. The method according to claim 10A wherein the method further comprises:
sending, in a case that the method is performed by the LMF and in a scenario of downlink positioning or uplink-downlink combined positioning, second assistance information to a terminal, wherein the second assistance information is used for assisting the terminal in determining the positioning integrity, and the second assistance information comprises at least one of: a position error (PE), a target integrity risk (TIR), an alert limit (AL), or time-to-alert (TTA).

23-27. (canceled)

28. A terminal, comprising:
a processor;
a transceiver connected to the processor; and
a memory for storing an executable instruction for the processor; wherein
the processor is configured to load and execute the executable instruction to perform the following method:
sending first assistance information, wherein the first assistance information is used for assisting a location management function (LMF) in determining the positioning integrity of the terminal.

29. A location management function (LMF) or an access network device, comprising:
a processor;
a transceiver connected to the processor; and
a memory for storing an executable instruction for the processor; wherein
the processor is configured to load and execute the executable instruction to perform the method for determining positioning integrity according to claim 10.

30. (canceled)

31. A non-transitory computer-readable storage medium, storing an executable instruction, wherein the executable instruction is loaded and executed by a processor to implement the method for determining positioning integrity according to claim 1.
